(19) United States
(12) Patent Application Publication
(10) Pub. No.: US 2011/0068286 A1
(43) Pub. Date: Mar. 24, 2011

(54) SOLENOID ON-OFF VALVE

(75) Inventors: Kaoru NOMICHI, Ono-shi (JP); Yutaka SUZUKI, Kobe-shi (JP); Makoto NINOMIYA, Kobe-shi (JP); Hiroshi ITOH, Kakogawa-shi (JP)

(73) Assignee: Kawasaki Jukogyo Kabushiki Kaisha, Kobe-shi (JP)

(21) Appl. No.: 12/877,298

(22) Filed: Sep. 8, 2010

(30) Foreign Application Priority Data
Sep. 11, 2008 (JP) 2008-233573

(51) Int. Cl. F16K 31/02

(52) U.S. Cl. 251/129.15

(57) ABSTRACT

In a solenoid on-off valve 20, a main valve body 22 is provided to be displaceable with respect to a housing having a valve passage 55. A seat member 25 is provided at the main valve body 22. The seat member 25 is pressed on a valve seat 34, which divides the valve passage 55 into a primary space 56 and a secondary space 57, to close the valve passage 55. A pilot valve body 23 is coupled to the main valve body 22 so as to be relatively displaceable with respect to the main valve body 22. The pilot valve body 23 is configured to be displaced by an electromagnetic force of an electromagnetic drive unit 24. Further, the solenoid on-off valve 20 is configured such that: the seat member 25 includes a pilot passage 40 connecting the primary space 56 and the secondary space 57; and the pilot valve body 23 is pressed on the seat member 25 to close the pilot passage 40.

### BACKGROUND OF THE INVENTION

1. Field of the Invention

The present invention relates to a solenoid on-off valve configured to open and close a passage through which a fluid flows.

2. Description of the Related Art

FIG. 6 is a cross-sectional view showing a solenoid on-off valve 1 described in Japanese Laid-Open Patent Application Publication No. 2005-83533. The solenoid on-off valve 1 is provided in a fluid apparatus, such as a high-pressure gas tank, and is configured to be able to open and close a passage. The solenoid on-off valve 1 includes a housing 2, a main valve body 3, a pilot valve body 4, and an electromagnetic drive unit 5. A valve passage 6 connecting a primary port and a secondary port is formed at the housing 2. The valve passage 6 is divided into a primary space 8 and a secondary space 9 by a valve port 7a defined by a valve seat 7 of the housing 2. The primary space 8 is connected to the primary port, and the secondary space 9 is connected to the secondary port.

Further, the main valve body 3 having a bottomed tubular shape is provided in the housing 2 so as to be displaceable. A pilot passage 10 penetrating in an axial direction is formed at a bottom portion 3a of the main valve body 3. Further, a main seat member 11 is provided at the bottom portion of the main valve body 3. The main seat member 11 is provided to surround an outer opening of the pilot passage 10 and is configured to be pressed (seated) on the valve seat 7. The main seat member 11 is pressed on the valve seat 7, so that the main valve body 3 closes the valve port 7a to close the valve passage 6.

A tip end portion 4a of the pilot valve body 4 is inserted into the main valve body 3. The main valve body 3 and the pilot valve body 4 are coupled to each other so as to be relatively displaceable. A valve seat 12 is formed at the bottom portion 3a of the main valve body 3 so as to surround an opening of the pilot passage 10. The valve seat 12 projects toward the tip end portion 4a of the pilot valve body 4. A sub seat member 13 is provided at the tip end portion 4a of the pilot valve body 4 so as to be pressed on the valve seat 12. The sub seat member 13 is pressed on the valve seat 12, so that the pilot valve body 4 closes the pilot passage 10. An electromagnetic drive unit 5 is provided at the pilot valve body 4. The electromagnetic drive unit 5 causes the pilot valve body 4 to be displaced by electric power. By causing the pilot valve body 4 to be displaced, the main valve body 3 coupled thereto moves.

By driving the electromagnetic drive unit 5, the pilot valve body 4 is relatively displaced with respect to the main valve body 3, the sub seat member 13 is separated from the valve seat 12, and the pilot passage 10 opens. Thus, the primary space 8 is connected to the secondary space 9 through the pilot passage 10, and the pressure of the secondary space 9 increases. By the pressure increase of the secondary space 9, a pressure difference between the primary space 8 and the secondary space 9 decreases. When the pressure difference becomes a predetermined pressure, the main valve body 3 moves to separate the main seat member 11 from the valve seat 7. With this, the primary space 8 and the secondary space 9 are connected to each other through the valve port 7a, and a gas in a pressure apparatus is supplied through the valve port 7a to an external device.

In valves, such as the solenoid on-off valve 1, of prior arts, in order to prevent the gas from leaking from the primary space 8 to the secondary space 9, generally, high processing accuracy is required for the main seat member 11 and the sub seat member 13. Moreover, in the valves of the prior arts, such as the solenoid on-off valve 1 including the main valve body 3 and the pilot valve body 4, these parts need to be placed with high positional accuracy when assembling them. In addition, considerably high positional accuracy is required for the main seat member 11 provided at the main valve body 3 and the sub seat member 13 provided at the pilot valve body 4. In order to secure this considerably high positional accuracy, further high processing accuracy is required for the main seat member 11 and the sub seat member 13. Therefore, if the main seat member 11 and the sub seat member 13 are manufactured with extremely high processing accuracy as required, a large amount of labor is required for the manufacture of the solenoid on-off valve 1, and the manufacturing cost and the quality control cost become high.

Moreover, in the solenoid on-off valve 1, the main seat member 11 and the sub seat member 13 are respectively fixed to the main valve body 3 and the pilot valve body 4 by an adhesive or the like. Therefore, each of the main seat member 11 and the sub seat member 13 is low in a repeated stress durability and a thermal durability. Regarding the adhesive fixing, since the main seat member 11 and the sub seat member 13 move when fixing them, the positioning thereof is difficult, and it is difficult to secure the alignment of the main seat member 11 and the sub seat member 13 with respect to the main valve body 3, the pilot valve body 4, and the like with high accuracy.

### SUMMARY OF THE INVENTION

Here, a first object of the present invention is to provide a solenoid on-off valve which is easily manufactured even if high accuracy (such as flatness, squareness, and surface roughness) is required for a seat member.

A second object of the present invention is to provide a solenoid on-off valve in which the repeated stress durability and thermal durability of a portion of the seat member which portion is fixed to a main valve body are improved.

A third object of the present invention is to provide a solenoid on-off valve capable of easily positioning the seat member with respect to the main valve body.

A solenoid on-off valve of the present invention includes: a housing including a primary space connected to a primary port, a secondary space connected to a secondary port, and a valve port defined by a valve seat and connecting the primary space and the secondary space; a main valve body provided in the housing to be displaceable; a seat member provided at the main valve body and pressed on the valve seat to close the valve port; a pilot valve body coupled to the main valve body and relatively displaceable with respect to the main valve body; and an electromagnetic drive unit configured to displace the pilot valve body by an electromagnetic force, wherein the seat member is configured such that: a pilot passage is formed to connect the primary space and the secondary space; and the pilot valve body is pressed on the seat member to close the pilot passage.

In accordance with the present invention, the seat member which is pressed on the valve seat to close the valve port is configured such that the pilot valve body can be pressed on the seat member. With this, although the main seat member and the sub seat member are respectively provided at the main valve body and the pilot valve body in the prior art, the main seat member and the sub seat member can be integrally formed. Thus, the parts requiring high positional accuracy can be omitted from the prior art, and portions where the positional accuracy needs to be defined can be reduced as compared to the prior art. Moreover, by forming the pilot passage on the seat member, it becomes unnecessary to define the positional accuracy between the seat member and the pilot passage during assembly. With this, again, the portions where the positional accuracy needs to be defined can be reduced as compared to the prior art. As above, the number of portions where the positional accuracy needs to be defined is small. Therefore, the manufacture is easier than the prior art,

In the above invention, it is preferable that: the main valve body include at one end portion thereof a through hole portion through which the seat member is inserted; and the seat member include at an axially intermediate portion of an outer peripheral wall thereof a flange portion projecting in a radially outward direction and be fixed to the main valve body by fitting the flange portion in a concave portion formed at an axially intermediate portion of the through hole portion.

In accordance with the above configuration, by fitting the flange portion of the seat member in the concave portion of the through hole portion of the main valve body, the seat member is fixed to the main valve body without adhering the seat member to the main valve body. With this, the repeated stress durability and the thermal durability, which deteriorate by adhering different materials such as resin and metal, do not deteriorate. Therefore, the durabilities can be improved than before, and the reliability further improves.

In the above invention, it is preferable that: the through hole portion of the main valve body and the outer peripheral wall of the seat member be formed such that in a state where the seat member is pressed on the valve seat, a fluid flowing therebetween is introduced to the primary space.

In accordance with the above configuration, even if a portion between the through hole portion of the main valve body and the outer peripheral wall of the seat member is not completely sealed, the fluid in the primary space does not leak to the secondary space while the seat member is pressed on the valve seat. Therefore, the processing accuracy of the through hole portion of the main valve body and the outer peripheral wall of the seat member can be reduced. Thus, the main valve body and the seat member can be easily manufactured, and the manufacturing cost can be reduced.

In the above invention, it is preferable that the seat member be formed by insert molding in the through hole portion of the main valve body. In accordance with the above configuration, the seat member is formed by insert molding in the main valve body, and the positioning of the seat member with respect to the main valve body is easy. Therefore, the manufacturing cost is reduced.

The above and further objects and features of the invention will more fully be apparent from the following detailed description with accompanying drawings.

### BRIEF DESCRIPTION OF THE DRAWINGS

FIG. 1 is a cross-sectional view showing a solenoid on-off valve 20 of Embodiment 1 of the present invention.

FIG. 2 is a cross-sectional view enlarging a periphery of a seat member 25 of FIG. 1.

FIG. 3(a) is a cross-sectional view showing a state where a pilot valve body 23 is separated from the seat member 25. FIG. 3(b) is a cross-sectional view showing a state where the seat member 25 is separated from a valve seat 34.

FIG. 4 is a cross-sectional view enlarging a periphery of a seat member 25A of a solenoid on-off valve 20A of Embodiment 2 of the present invention.

FIG. 5 is a cross-sectional view enlarging a periphery of a seat member 25B of a solenoid on-off valve 20B of Embodiment 3 of the present invention.

FIG. 6 is a cross-sectional view showing the solenoid on-off valve 1 described in Japanese Laid-Open Patent Application Publication No. 2005-83533.

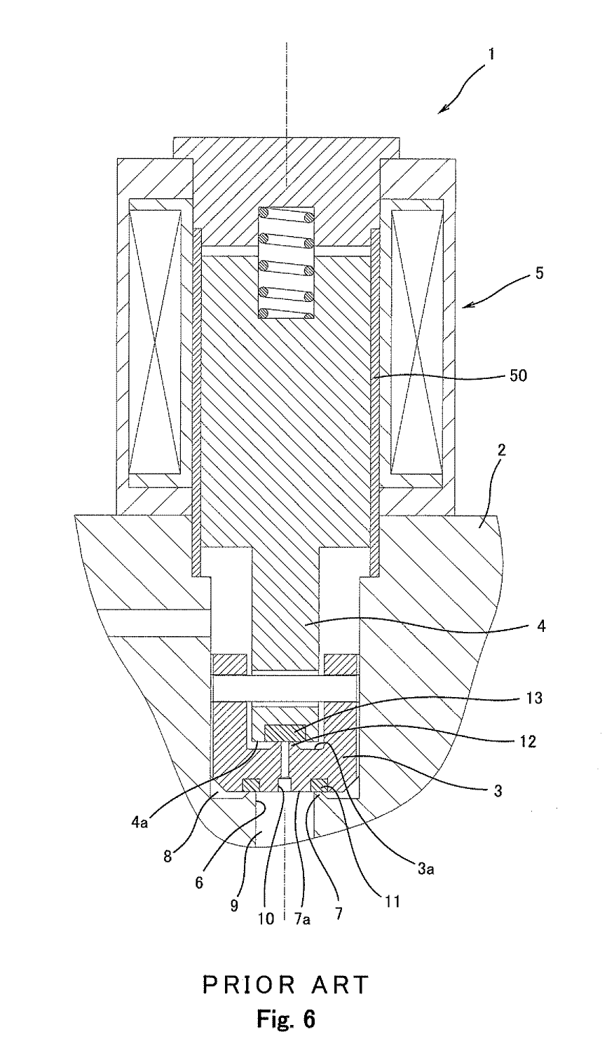

### DESCRIPTION OF THE PREFERRED EMBODIMENTS

### Embodiment 1

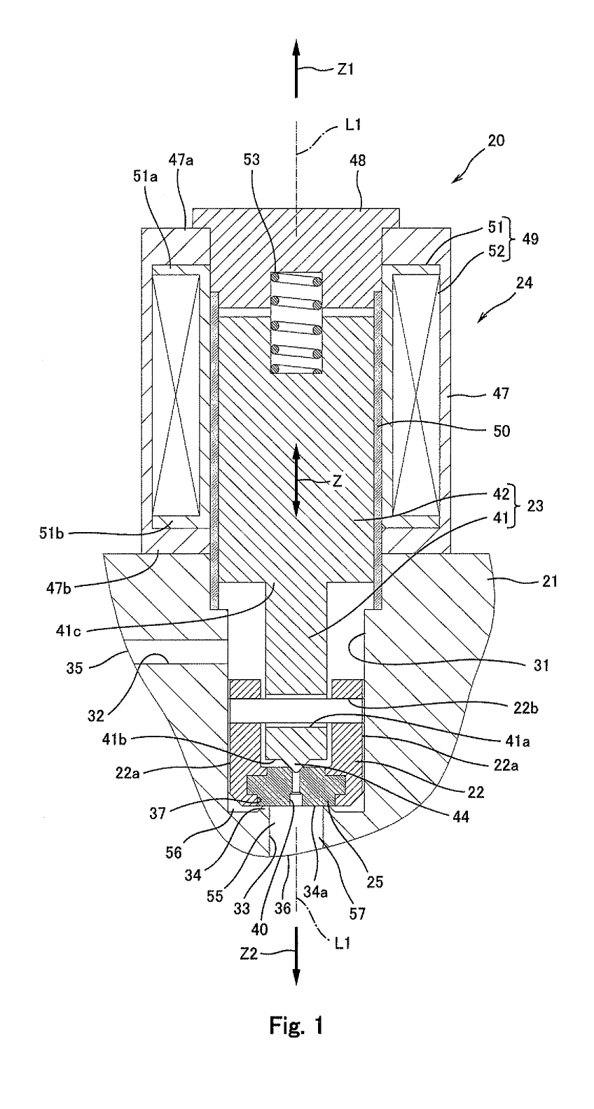

FIG. 1 is a cross-sectional view showing a solenoid on-off valve 20 of Embodiment 1 of the present invention. The solenoid on-off valve 20 is provided at a high-pressure gas tank (hereinafter may be simply referred to as a “tank”), such as a fuel tank of a natural gas vehicle, configured to store a high-pressure combustible gas (hereinafter may be simply referred to as a “gas”). The solenoid on-off valve 20 is a valve device configured to control the output of the gas in the tank.

The solenoid on-off valve 20 includes a housing 21, a main valve body 22, a seat member 25, a pilot valve body 23, and an electromagnetic drive unit 24. The solenoid on-off valve 20 has a reference axis line L1, and an axis of each of the housing 21, the main valve body 22, the seat member 25, the pilot valve body 23, and the electromagnetic drive unit 24 coincides with the reference axis line L1 In the following, a direction along the reference axis line L1 is referred to as an axial direction Z, an upward direction on the sheet of FIG. 1 is referred to as a first axial direction Z1, and a downward direction on the sheet of FIG. 1 is referred to as a second axial direction Z2.

A valve chest 31 is formed at the housing 21 along the reference axis line L1 so as to open in the first axial direction Z1. Moreover, a primary passage 32 extending in a direction perpendicular to the reference axis line L1 is formed at the housing 21. The primary passage 32 has one end connected to the valve chest 31 and the other end connected to the inside of the tank. Further, a secondary passage 33 is formed at the housing 21 along the reference axis line L1. The secondary passage 33 has one axial end connected to the valve chest 31 and the other end connected to a device, such as an engine of a natural gas vehicle, located outside the tank. A valve seat 34 having an annular shape projecting in the first axial direction Z1 is formed around an opening of the secondary passage 33 which opening faces the valve chest 31. In the present embodiment, an opening of the primary passage 32 which opening faces the inside of the tank is a primary port 35, and an opening of the secondary passage 33 which opening faces the device located outside the tank is a secondary port 36. Then, a valve port 34a is defined inside a tip end of the valve seat 34.

The main valve body 22 is provided in the valve chest 31 of the housing 21 so as to be displaceable in the axial direction Z. The main valve body 22 is made of a metal material, such as brass or stainless steel, and is formed to have a bottomed cylindrical shape. A plurality of grooves 22a each extending in the axial direction of the main valve body 22 from one end to the other end are formed on an outer peripheral portion of the main valve body 22 so as to be arranged in a circumferential direction at regular intervals. Then, a through hole portion 37 penetrating in the axial direction is formed at a bottom portion of the main valve body 22. The seat member 25 fits in the through hole portion 37. Moreover, the pilot valve body 23 is inserted in an opening of the main valve body 22 which opening opens in the first axial direction Z1.

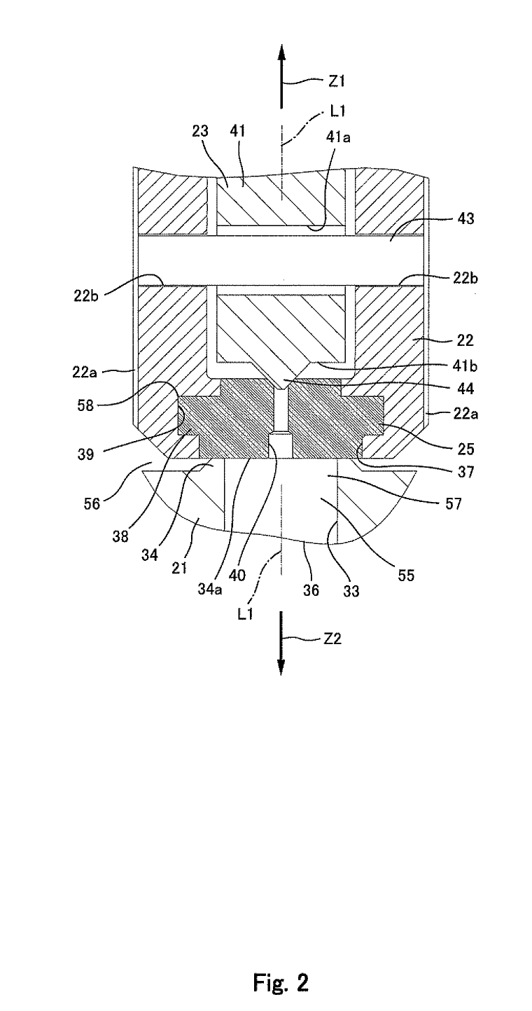

FIG. 2 is a cross-sectional view enlarging a periphery of the seat member 25 of FIG. 1. The seat member 25 is made of synthetic resin or synthetic rubber. Specifically, the seat member 25 is made of PEEK (polyether ether ketone) resin, fluoroethylene resin, polyacetal resin, or nylon monomer. The seat member 25 has a substantially disc shape, and an outer shape of the seat member 25 substantially coincides with the shape of an inner peripheral surface of the through hole portion 37. A flange portion 38 projecting in a radially outward direction is formed at an axially intermediate portion of the outer peripheral portion of the seat member 25 over the entire outer peripheral portion in a circumferential direction. Then, a concave portion which is concave toward the radially outward direction is formed at the through hole portion 37 of the main valve body 22. The flange portion 38 fits in the concave portion 39, so that the seat member 25 is fixed.

As above, the seat member 25 is fixed to the main valve body 22 without adhering the seat member 25 to the main valve body 22. Therefore, the repeated stress durability and the thermal durability, which deteriorate by adhering different materials such as resin and metal, do not deteriorate. Therefore, the durabilities can be improved than before, and the reliability further improves.

Moreover, the seat member 25 has a first axial end portion, which is larger in diameter than the valve port 34a and is pressed (seated) on the valve seat 34. The seat member 25 is pressed on the valve seat 34 to close the valve port 34a. Further, a pilot passage 40 penetrating along the reference axis line L1 is formed at the seat member 25.

The following will be explained in reference to FIGS. 1 and 2. The pilot valve body 23 is made of ferromagnet, such as electromagnetic stainless steel. The pilot valve body 23 is constituted by integrally forming a small-diameter pilot valve portion 41 and a large-diameter movable core 42 and has a substantially columnar shape. A tip end portion of the pilot valve portion 41 is inserted into the main valve body 22. The pilot valve portion 41 and the main valve body 22 are coupled to each other such that a coupling pin 43 is inserted into a coupling hole 41a of the pilot valve portion 41 and a coupling hole 22b of the main valve body 22. Each of the coupling holes 41a and 22b extends in a direction perpendicular to the reference axis line L1. The diameter of the coupling hole 41 a of the pilot valve portion 41 is larger than an outer diameter of the coupling pin 43. Therefore, the pilot valve body 23 is configured to be relatively displaceable with respect to the main valve body 22 in the axial direction Z.

Moreover, a pilot valve seat portion 44 is formed at a tip end 41b of the pilot valve portion 41. The pilot valve seat portion 44 projects in the second axial direction Z2 and has a tapered shape which tapers toward a tip end thereof. The pilot valve seat portion 44 is pressed on the seat member 25 such shat a tip end portion thereof fits in the pilot passage 40. The pilot valve portion 41 is configured to close the pilot passage 40 such that the tip end portion of the pilot valve seat portion 44 is pressed on the seat member 25. The movable core 42 is integrally provided at a base end 41c of the pilot valve portion 41. Then, the electromagnetic drive unit 24 configured to displace the movable core 42 is provided at the movable core 42.

The electromagnetic drive unit 24 includes a solenoid casing 47, a fixed magnetic pole 48, a coil member 49, and a guide member 50. The solenoid casing 47 is formed to have a substantially cylindrical shape and includes inward flange portions 47a and 47b respectively at both end portions of the axial direction Z, each of the inward flange portions 47a and 47b extending in a radially inward direction. The coil member 49 fits between these two inward flange portions 47a and 47b. The coil member 49 includes a bobbin 51 and a coil 52. The bobbin 51 is formed to have a substantially cylindrical shape and includes outward flange portions 51a and 51b respectively at both end portions of the axial direction Z, each of the outward flange portions 51a and 51b extending in the radially outward direction. Then, the coil 52 around which a coil wire winds is provided between these outward flange portions 51a and 51b. Moreover, the fixed magnetic pole 48 made of ferromagnet fits in an opening of the solenoid casing 47 which opening opens in the first axial direction Z1.

Further, the guide member 50 is provided inside the solenoid casing 47. The guide member 50 is provided at the housing 21 such that an opening thereof which opens in the second axial direction Z2 is connected to the valve chest 31 of the housing 21. Moreover, the movable core 42 is inserted in the guide member 50 from the opening which opens in the second axial direction Z2, and the movable core 42 reaches the inside of the coil member 49. A second axial end portion of the movable core 42 faces a first axial end portion of the fixed magnetic pole 48. A compression coil spring 53 is provided between these second axial end portion and first axial end portion. The movable core 42 and the fixed magnetic pole 48 are provided to be spaced apart from each other. The movable core 42 is pressed by the compression coil spring 53 in the second axial direction Z2. Therefore, the pilot valve seat portion 44 of the pilot valve portion 41 is pressed against the seat member 25.

In the present embodiment, the secondary passage 33, the valve chest 31, and the primary passage 32 constitute a valve passage 55. In the valve passage 55, a space located on the primary port 35 side of the valve port 34a is a primary space 56, and a space located on the secondary port 36 side of the valve port 34a is a secondary space 57. Therefore, the primary space 56 and the secondary space 57 are connected to each other by the valve port 34a.

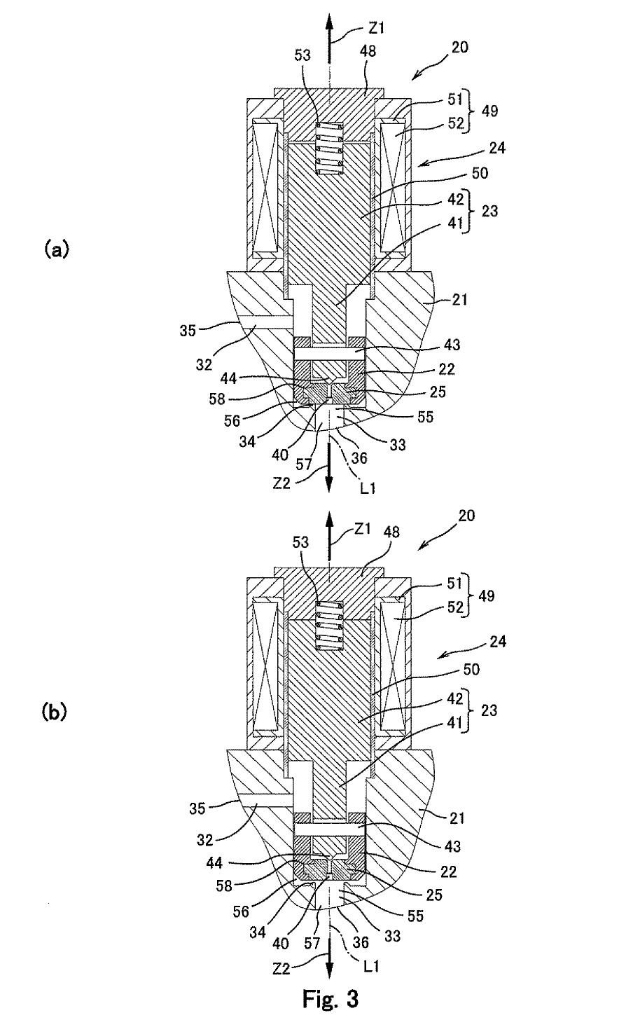

FIG. 3(a) is a cross-sectional view showing a state where the pilot valve body 23 is separated from the seat member 25. FIG. 3(b) is a cross-sectional view showing a state where the seat member 25 is separated from the valve seat 34. In the solenoid on-off valve 20, both the pilot passage 40 and the valve passage 55 are closed with the current not flowing through the coil 52. With this, the primary space 56 and the secondary space 57 are blocked. In this case, depending on the processing accuracy of the seat member 25 and the main valve body 22, a portion between the seat member 25 and the through hole portion of the main valve body 22 may not be completely sealed, and a gap 58 may be formed. However, since the first axial end portion of the seat member 25 is formed to be larger in diameter than the valve port 34a, the gap 58 is connected to a space located on the radially outward side of the valve seat 34, that is, the primary space 56. Therefore, the gas is prevented from leaking from the gap 58 to the secondary space 57. On this account, the processing accuracy of the through hole portion 37 of the main valve body 22 and an outer peripheral wall of the seat member 25 can be reduced. Thus, the main valve body 22 and the seat member 25 can be easily manufactured, and the manufacturing cost can be reduced.

Next, in the solenoid on-off valve 20, when the current flows through the coil 52, a magnetic force is generated, and the movable core 42 and the fixed magnetic pole 48 are magnetized. By this magnetization, the movable core 42 is magnetically attracted to the fixed magnetic pole 48, and a force in a direction toward the fixed magnetic pole 48 (that is, the first axial direction Z1) is applied to the movable core 42. With this, the pilot valve body 23 is relatively displaced with respect to the main valve body 22 in the first axial direction Z1 until the coupling pin 43 contacts the pilot valve body 23. Thus, as shown in FIG. 3(a), the pilot valve seat portion 44 is separated from the pilot passage 40, and the pilot passage 40 opens. By opening the pilot passage 40, the primary space 56 and the secondary space 57 are connected to each other by the pilot passage 40, and the pressure of the secondary space 57 increases.

By the increasing of the pressure of the secondary space 57, the pressure difference between the primary space 56 and the secondary space 57 decreases. When the pressure difference becomes a predetermined pressure, the main valve body 22 is pulled in the first axial direction Z1. by the pilot valve body 23 which is displaced by the magnetic force of the coil 52, and the main valve body 22 moves in the first axial direction Z1. By the movement of the main valve body 22, the seat member 25 is separated from the valve seat 34, and the valve passage 55 opens. Thus, the gas in the tank flows through the valve passage 55 to the device located outside the tank. Specifically, the gas in the tank flows through the primary passage 32, enters into the valve chest 31, flows through the grooves 22a of the main valve body 22, is introduced into the secondary passage 33, and flows to the device located outside the tank.

By stopping the current flowing through the coil 52, the magnetic force applied to the pilot valve body 23 disappears, and the pilot valve body 23 is pressed on the seat member 25 by the pressing force of the compression coil spring 53. With this, the pilot passage 40 is closed. After that, the pilot valve body 23 which is continuously pressed by the compression coil spring 53 presses the main valve body 22 to cause the main valve body 22 to move in the second axial direction Z2. Then, the seat member 25 provided at the main valve body 22 is pressed on the valve seat 34 to close the valve passage 55.

In accordance with the solenoid on-off valve 20 of the present embodiment, the seat member 25 configured to be pressed on the valve seat 34 to close the valve passage 55 is configured such that the pilot valve body 23 can be pressed on the seat member 25. With this, although the main seat member 11 and the sub seat member 13 are respectively formed for the main valve body 3 and the pilot valve body 4 in the prior art, the main seat member 11 and the sub seat member 13 can be integrally formed. Thus, the parts requiring high positional accuracy can be omitted from the valve of the prior art, and portions where the positional accuracy needs to be defined can be reduced as compared to the valve of the prior art. Moreover, by forming the pilot passage 40 on the seat member 25, it becomes unnecessary to define the positional accuracy between the seat member 25 and the pilot passage 40 during assembly. With this, again, the portions where the positional accuracy needs to be defined can be reduced as compared to the prior art. As above, the number of portions where the positional accuracy needs to be defined is small. Therefore, even if high accuracy (such as flatness, squareness, and surface roughness) is required for the seat member 25, high processing accuracy after assembly can be achieved more easily than the prior art, and the manufacture is easier than the prior art.

The seat member 25 of the present embodiment is formed by insert molding in the main valve body 22. Therefore, the positioning of the seat member 25 with respect to the main valve body 22 is easy. On this account, the manufacturing cost is reduced.

### Embodiment 2

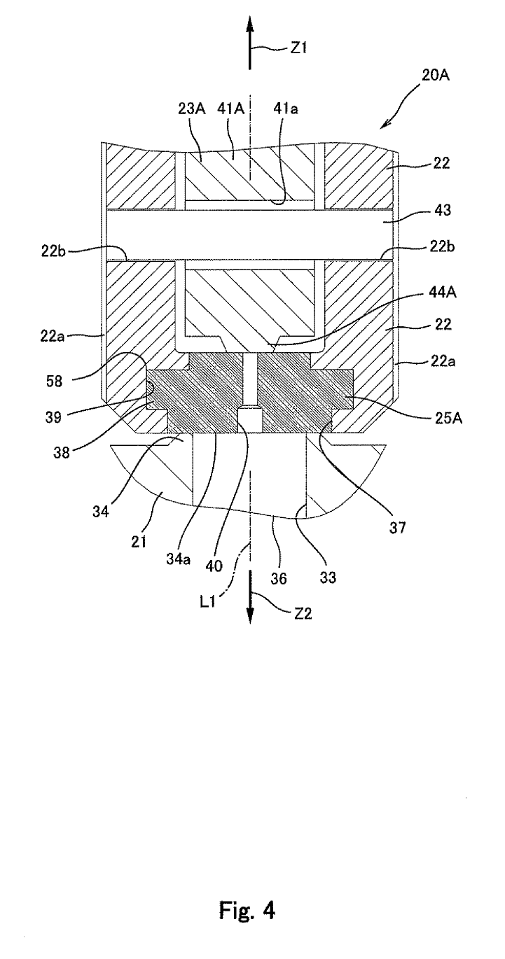

FIG. 4 is a cross-sectional view enlarging a periphery of a seat member 25A of a solenoid on-off valve 20A of Embodiment 2 of the present invention. The configuration of solenoid on-off valve 20A of Embodiment 2 is similar to that of the solenoid on-off valve 20 of Embodiment 1. Therefore, in the following, only components of the solenoid on-off valve 20A of Embodiment 2 which are different from the components of the solenoid on-off valve 20 of Embodiment 1 will be explained. The same reference numbers are used for the same components, and a repetition of the same explanation is avoided. The same is true for a solenoid on-off valve 20B of Embodiment 3 described below. A pilot valve seat portion 44A formed at a tip end of a pilot valve portion 41A of a pilot valve body 23A has a tapered shape which tapers toward a tip end thereof, and the tip end of the pilot valve seat portion 44A is formed to be flat. The tip end portion of the pilot valve seat portion 44A does not fit in the pilot passage 40 of the seat member 25A but is pressed on the seat member 25A to close the pilot passage 40.

The solenoid on-off valve 20A of the present embodiment has the same operational advantages as the solenoid on-off valve 20 of Embodiment 1.

### Embodiment 3

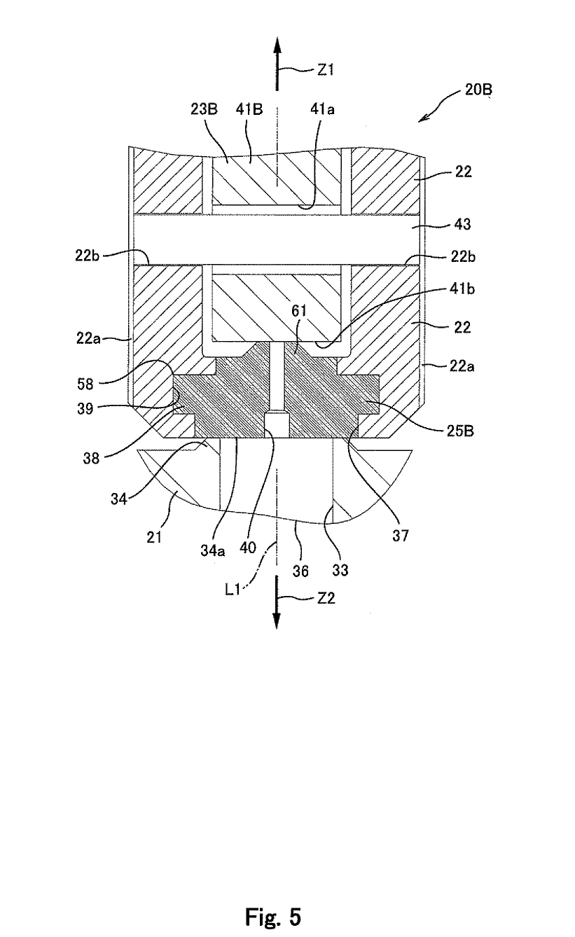

FIG. 5 is a cross-sectional view enlarging a periphery of a seat member 25B of the solenoid on-off valve 2013 of Embodiment 3 of the present invention. The seat member 25B includes a valve seat 61 at a second axial end portion thereof. The valve seat 61 is formed in an annular shape so as to surround a periphery of the pilot passage 40 and projects in the first axial direction Z1. Moreover, a tip end of a pilot valve portion 41B of a pilot valve body 23B is formed to be flat and is configured to be pressed on the valve seat 61. When the pilot valve portion 41B is pressed on the valve seat 61, the pilot passage 40 is closed.

The solenoid on-off valve 20B of the present embodiment has the same operational advantages as the solenoid on-off valve 20 of Embodiment 1.

Embodiments 1 to 3 has explained a case where the present invention is applied to the high-pressure gas tank. However, the present invention may be applied to a hydraulic device, and the fluid used is not limited to the gas. Moreover, Embodiments 1 to 3 has explained a case where the housing 2 and the solenoid casing 47 are separately formed. However, these may be integrally founed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A solenoid on-off valve comprising:
a housing including a primary space connected to a primary port, a secondary space connected to a secondary port, and a valve port defined by a valve seat and connecting the primary space and the secondary space;
a main valve body provided in the housing to be displaceable;
a seat member provided at the main valve body and pressed on the valve seat to close the valve port;
a pilot valve body coupled to the main valve body and relatively displaceable with respect to the main valve body; and
an electromagnetic drive unit configured to displace the pilot valve body by an electromagnetic force, wherein
the seat member is configured such that: a pilot passage is formed to connect the primary space and the secondary space; and the pilot valve body is pressed on the seat member to close the pilot passage.

2. The solenoid on-off valve according to claim 1, wherein:
the main valve body includes at one end portion thereof a through hole portion through which the seat member is inserted; and
the seat member includes at an axially intermediate portion of an outer peripheral wall thereof a flange portion projecting in a radially outward direction and is fixed to the main valve body by fitting the flange portion in a concave portion formed at an axially intermediate portion of the through hole portion.

3. The solenoid on-off valve according to claim 2, wherein the through hole portion of the main valve body and the outer peripheral wall of the seat member are formed such that in a state where the seat member is pressed on the valve seat, a fluid flowing therebetween is introduced to the primary space.

4. The solenoid on-off valve according to claim 2, wherein the seat member is formed by insert molding in the through hole portion of the main valve body.
